(19) United States
(12) Patent Application Publication
(10) Pub. No.: US 2004/0055402 A1
(43) Pub. Date: Mar. 25, 2004

(54) Probe holder

(75) Inventors: Marc Pensis, Preston, CT (US); Wayne Byassee, North Stonington, CT (US)

Correspondence Address: PFIZER INC, 150 EAST 42ND STREET, 5TH FLOOR - STOP 49, NEW YORK, NY, 10017-5612, US

(73) Assignee: Pfizer Inc.

(21) Appl. No.: 10/616,902

(22) Filed: Jul. 10, 2003

Related U.S. Application Data
(60) Provisional application No. 60/394,762, filed on Jul. 10, 2002.

(51) Int. Cl. G01D 3/036; G01N 21/15

(52) U.S. Cl. 73/866.5; 73/73; 250/338.5

(57) ABSTRACT

A near infra red probe is received in a holder which is mounted within the wall of an enclosed process vessel for reading and determining the moisture content of a product undergoing processing or drying, wherein the holder is formed with conduits, and a gas, such as air or nitrogen, is transmitted in periodic high pressure pulses through the holder conduits and transversely across the detecting end face of the probe to clear the probe end face of moisture and particulate contaminants to provide accurate real time moisture content determinations.

### BACKGROUND OF THE INVENTION

1. Field of the Invention

This invention relates to holders for detecting probes. This invention also relates to a system and method for the accurate detection of a substance with a probe. In a more specific respect, this invention relates to a holder, system and method for accurate process material moisture content determinations with infra red and near infra red probes.

2. Background and Discussion of the Prior Art

Infra red probes are used to detect moisture content in various production operations, such as in paper mill processing and wood drying. Infra red probe readings are often inaccurate in that moisture or contaminants collect on the detecting end of the probe thereby introducing errors in the moisture content reading.

In pharmaceutical process operations, it is important to accurately determine the moisture content of the process material in dryers and processing vessels for controlled drying or processing. Overdrying adversely impacts on crystal size in drying pharmaceutical crystals. Crystal size and shape is a factor in pharmaceutical properties, and accurate moisture content determination in crystal is therefore imperative. The present pharmaceutical process technique product moisture content determination entails use of sample collectors. In such process techniques, the operator periodically opens the process vessel and uses the sample collector to collect a sample from the product mass or slurry. The collector with sample is taken to a laboratory for moisture content analysis. The moisture content determination is then communicated to the process operator for process control adjustment or even shutdown. This technique is unduly time consuming, labor intensive, necessitates disruptive entry into the process vessel, and the moisture content determination is not in ongoing real processing time. Further, the sample removal from the otherwise closed process vessel in itself may introduce outside moisture or contaminants with consequential additional error in the moisture product content determination.

A direct, online, rapid and accurate means for moisture content determination of product in dryers and other process vessels is desired for pharmaceutical processing especially with the moisture content determination being effectively free of contaminant and non-product moisture induced error and process disruption.

### SUMMARY OF THE INVENTION

A moisture detecting probe is mounted in a holder, which holder includes a gas distribution conduit to provide gas at a predetermined sufficiently high pressure across the detecting end of the probe to clear the probe of contaminants and moisture.

The detecting probe and holder combination of the present invention, in one preferred embodiment, is disposed in the wall of an enclosed process vessel or chamber to determine the moisture content of a product undergoing processing or drying. A near infra red probe is used to detect the moisture content. A controller is operably connected to the vessel so that at predetermined periodic intervals just prior to each desired moisture content determination, a high pressure pulse of gas, such as air or nitrogen, is provided to the holder conduits and transversely across the detecting end face of the near infra red probe. The high pressure pulsed gas assuredly clears the probe detecting end of residual moisture and/or particulates. The controller then immediately actuates the probe for a real time accurate moisture content reading.

The gas may be initially provided by a supply controller at a constant low pressure purge of no more than about 10 psi, and immediately prior to the probe reading, the controller is actuated to supply the gas at a higher pressure of 10 to 45 psi or more to assuredly clear the probe detecting end. The high pressure gas purge is terminated. A master controller actuates the probe immediately after the high pressure gas purge is terminated. The low pressure gas purge is then reinstituted until just prior to the next desired predetermined probe reading.

In a more specific preferred embodiment, the present invention includes one or more of the foregoing inventive features in operable combination with a pharmaceutical process vessel or dryer for an accurate real time determination of the moisture content of the pharmaceutical process material or product undergoing processing or drying.

### BRIEF DESCRIPTION OF THE DRAWINGS

FIG. 1 is a perspective exploded view of the probe holder and probe;

FIG. 2 is a sectional view of the probe holder taken along line 2-2 of FIG. 1, with the probe disposed in the holder;

FIG. 3 is a proximate end view of the coupler portion of the probe holder;

FIG. 4 is a proximate end perspective partial sectional view of the probe holder; and

FIG. 5 is a schematic block diagram of the system and method of the present invention.

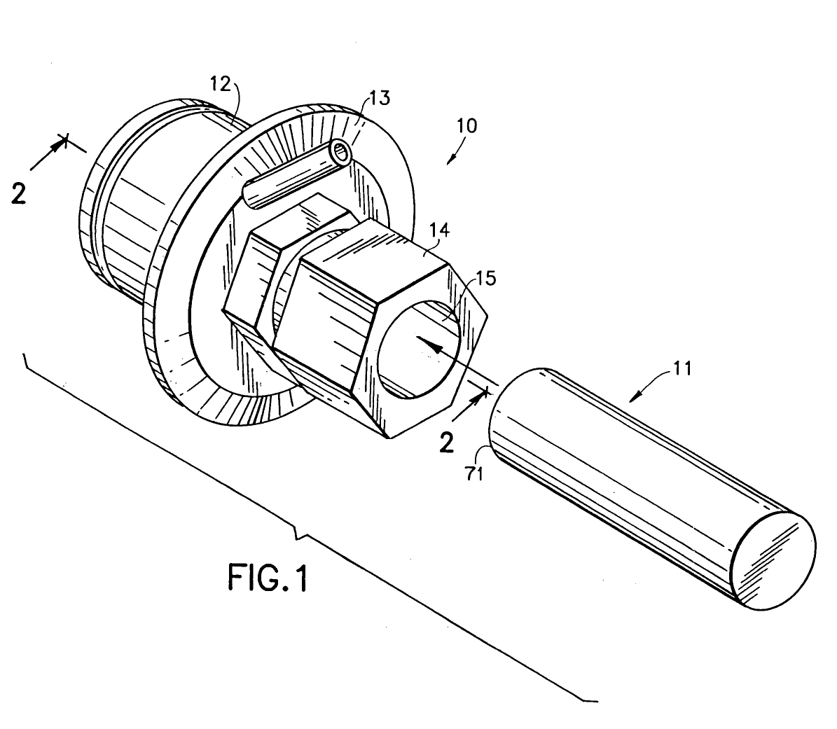

### DESCRIPTION OF THE PREFERRED EMBODIMENT

The terms “near infra red” and “NIR” as used hereinbefore and hereinafter throughout the specification and claims refer to wavelengths of between about 1100 and 2200 nm.

Referring to the FIGS., there is shown probe holder 10 and near infra red probe 11. Probe holder 10 is, in general terms, an integral assembly constructed of distally disposed tubular member or coupler 12, annular flange or manifold 13, and proximately disposed tubular lock member 14. Holder 10 slidably receives probe 11 in central orifice 15. Holder 10 is generally constructed of machined metal components, namely, coupler 12, flange 13 and lock member 14 which are slidably inter-fitted and welded in an integral construction.

Coupler 12 has a distally disposed annular end face 16, cylindrical outer wall 17 with distally disposed annular groove 18, a proximately disposed annular end wall 19, a first inner cylindrical wall 20 terminating in end wall 21, a second inner cylindrical wall 22 which forms a portion of central orifice 15, and a distally disposed cylindrical wall 92. End wall or lip 23 is disposed between and contiguous with walls 22 and 92. End wall 23 functions as an abutment or seat for the distal end 71 of probe 11. Probe 11, when seated against end wall 23, is in fluid tight disposition in holder 10 by means of a deformable swagelock (not shown) of well known construction disposed between probe 11 and holder central orifice 15. An O-ring (not shown) can also be provided to insure the fluid tight seal of the probe in the holder. Other fluid tight mechanical sealing means known in the art may likewise be used to securely hold probe 11 in holder central orifice 15.

A series of three spaced holes 25 (typical) are drilled in holder 10. Holes 25 are circumferentially disposed at 120_, and equally radially disposed with respect to central orifice axis 26. Holes 25 extend from coupler proximately disposed wall 19 to coupler distally disposed end face 16. A distal end weld plug 27 (typical) forms a blind hole for each respective hole 25. A series of three cross-holes 28 (typical) are drilled in holder 10. Cross-holes 28 are circumferentially disposed and extend from outer cylindrical surface 17 to inner cylindrical wall 92. Each cross-hole 28 intersects and communicates with a respective hole 25. Cross-hole 28 terminates in a respective end opening 30 in wall 92. Each cross-hole 28 has a radially disposed central axis 31 which is perpendicularly disposed to and intersects central orifice axis 26. A plug weld 32 (typical) forms a blind hole for each cross-hole 28. In this manner of construction, holes 25 are contiguous with respective cross-holes 28 to form respective channels or conduits for the simultaneous distribution of a gas in a radially inward direction through end openings 30, for purposes hereinafter appearing.

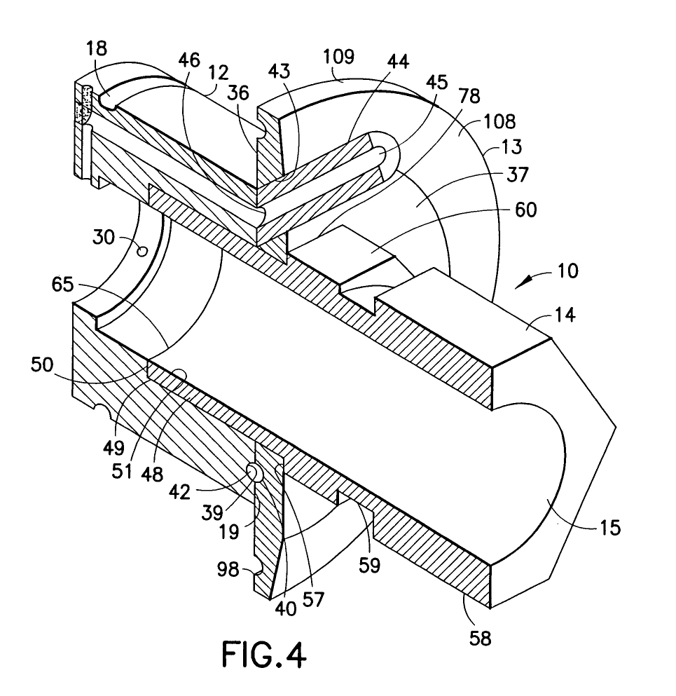

Coupler proximately disposed annular end wall 19 is formed with an annular semi-circular groove 39 which is contiguous with the distal end opening 35 (typical) of each respective hole 25. Flange 13 is formed with a distal wall 36, proximately radially inwardly disposed wall 37 and contiguous outwardly disposed wall 108. Contiguous walls 37 and 108 provide a frustoconical configuration which is cojoined to distal wall 36 by peripheral cylindrical wall 109 (FIG. 4). An annular semi-circular groove 40 is formed in flange distal wall 36 which is similarly sized to groove 39 so that when wall 36 abuts wall 19, complimentary grooves 39 and 40 form annular channel or orifice 42. An angularly disposed hole 43 is drilled in flange 13 to receive gas supply hose 44. Hose 44 has an inlet 45 and outlet 46. Hose outlet 46 is disposed within flange 13 and is contiguous with annular channel 42 and one of the coupler holes 25. Hose 44 is welded to flange 13 at circular mating corner 74. In this manner of construction, gas enters hose inlet 45, passes through hose 44 and outlet 46 into annular orifice 42, and then simultaneously distributed through each hole 25 to each cross-hole 28 and in turn to each respective end opening 30.

Lock member 14 Is formed with a distally extending cylindrical portion 48 having an outer surface or wall 49, transversely disposed distal end wall 50 and an inner cylindrical wall 51. Lock member end wall 50 abuts coupler end wall 21. Lock member inner cylindrical wall 51 is flush with coupler inner cylindrical wall 22 to form the full length of central orifice 15. A weld (not shown) is made at inner joining line 65 to provide an integral coupler and lock member construction (FIG. 4).

Flange 13 is formed with inner cylindrical wall 54 which is sized to slidably receive lock member outer wall 49. With flange 13 disposed between lock member 14 and cojoined to coupler 12, flange distal wall 36 abuts coupler wall 19, and flange proximate wall 37 abuts lock member wall 57. Lock member 14 is formed with proximate hexagonal outer peripheral portion 58, cylindrical portion 59, and hexagonal portion 60. Flange 13 is fixedly seated between lock member hexagonal portion 60 and coupler proximate end wall 19. Welds (not shown) are provided respectively at hexagonal mating line 78 and circular mating line 79 to provide an integral coupler, flange and lock member construction.

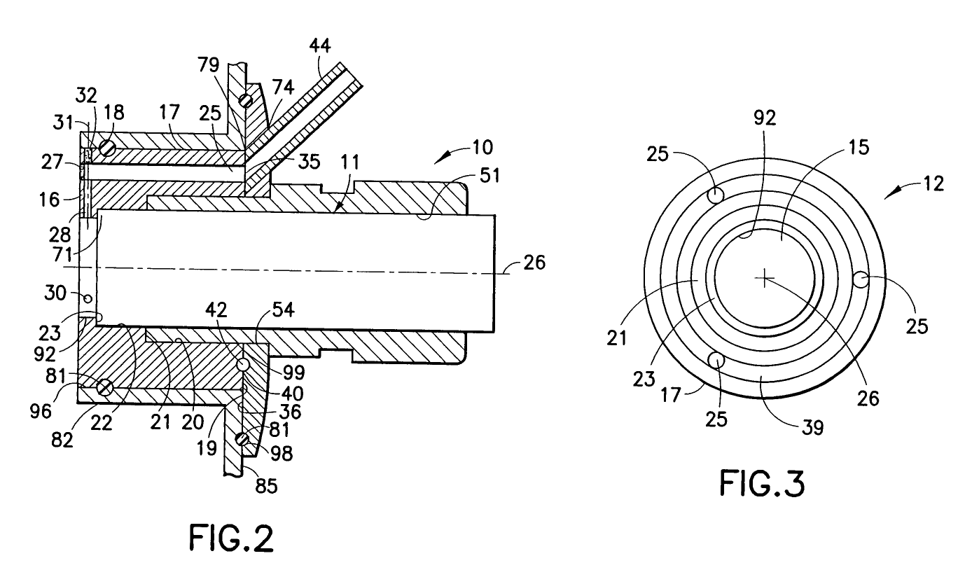

Coupler circumferential groove 18 and flange annular groove 98 are sized to receive respective O-rings 81 for fluid tight engagement within vessel wall mount or collar 82 of process vessel or chamber 85 (FIG. 2). Other fluid tight sealing means well known in the art are also within the contemplation of the invention.

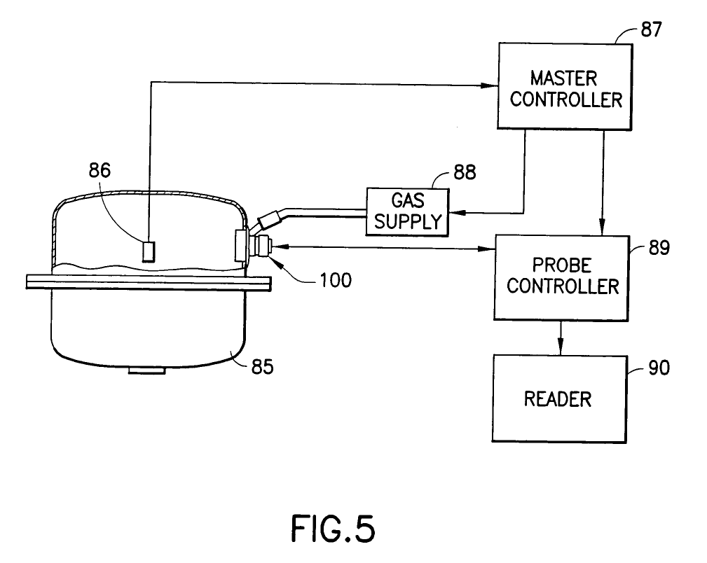

Referring specifically to FIGS. 2 and 5, the enclosed vessel or chamber 85 has an integral collar 82 which is formed with sleeve 96 into which holder 10 with probe 11 are slidably received, forming assembly 100. Assembly 100 is in fluid tight construction with respect to chamber 85 by means here-before described or by other vessel fluid tight constructions well known in the art. Gas supply controller 88 supplies gas to assembly 100 through hose 44 and holder 10, and in turn across the detecting end face of probe 11. A process instrument 86 is operably disposed with respect to vessel 85, so that at a predetermined process parameter or condition such as each rotation of process slurry mixer blade, a signal is transmited to master controller 87. Master controller 87 upon receipt of the signal actuates gas supply controller 88 to supply pressurized gas at a predetermined pressure to holder 10 to clear the probe detecting end face as hereinbefore described. Master controller 87 then immediately, after clearance of the probe detecting end face, signals probe controller 89 to take a probe reading. Probe 11 transmits the reading to probe controller 89 and in turn to a reader or recorder 90. An operator or automatic process controller (not shown) can then adjust the process parameters or shut down the process in accordance with the particular probe reading.

In a preferred embodiment, probe 11 is a near infra red (NIR) probe that detects the moisture content of the process material (not shown) in closed process vessel 85. A slurry mixer blade (not shown) rotates in the slurry (e.g. pharmaceutical product crystals) undergoing processing (e.g. drying). Master controller 87 actuates a low pressure gas (e.g. nitrogen) purge of about 5 to 10 psi across the end face of probe 11. Process instrument 86 detects each rotation of the slurry blade as it passes the probe 11, and accordingly signals master control 87 to actuate gas supply 88 to provide a surge or blast of high pressure gas at 10 to 45 psi or more across the sapphire crystal end face of the NIR probe to assuredly clear the probe distal end face. Master controller 87 then stops the high pressure gas surge momentarily and simultaneously actuates a probe moisture content reading via probe controller 89. The moisture content reading is transmitted to reader or recorder 90. The master controller 87 then actuates a low psi gas purge of about 5 to 10 psi, and repeats the probe reading cycle. In this manner, the invention provides an intra-vessel product moisture content determination which is free of error introduced by moisture and/or contaminants, and further provides a real time accurate moisture content determination without operator interface, undesired process disruption or process vessel opening. The process operator merely reads the reader and determines whether to adjust the process parameters or stop the process.

While the preferred embodiment is to provide low pressure and high pressure gas pulses, it is to be understood that other variations of gas pulses are within the contemplation of the invention. By way of example, it has been found that the low pressure pulse may be terminated when the product crystals slurry nascent liquid is greatly diminished as when the pharmaceutical crystals drying approaches the desired end point.

The present invention is particularly useful in, but not limited to, the formation and drying of crystals in the manufacture of pharmaceuticals. Insofar as overdrying adversely impacts crystal size, close monitoring of the moisture content of the crystals slurry is important. The afore-described preferred embodiment is particularly useful in such applications. It is however within the broad contemplation of the invention to use the probe holder in diverse environments, including by way of example, process vessels, reactors and dryers. The probe holder is preferably used in a closed vessel or chamber but may also be used in processing environments which communicate with the ambient air. Continuous as well as batch process operations are within the contemplation of the present invention.

The probe is preferably a near infra red probe of Hasteloy construction having flexible fiber optics which provide NIR through a detecting sapphire window end face onto the product undergoing moisture content determination. One preferred commercially available probe system useful in the present invention is the XDS NIR SmartProbe Analyzer manufactured by Foss, Silver Spring, Md. 20904. While the preferred embodiment is described with respect to an NIR probe and to a pharmaceutical product moisture content determination, it is within the contemplation of the invention to use the probe holder with other probes, by way of example, infra red probes and other types of substance or condition detecting probes having a detecting end face. The invention contemplates using any gas which is non-reactive with respect to the particular product and process. Useful gases are air, nitrogen, the inert gases (e.g. argon), and the like.

It is also within the contemplation of the present invention to provide fully automated cooperation between the probe readings and the process controllers, wherein by way of example, the process operations parameters would be automatically adjusted concomitantly with each periodic moisture content determination.

While the foregoing describes a preferred embodiment of the invention, it is within the ordinary skill of the practitioner to make obvious modifications and changes within the broad contemplation of the invention as set forth in the adjoined claims

What is claimed is:

1. A probe holder comprising:
means for holding a probe said probe having a detecting end, and means for providing a gas to the probe detecting end to clear moisture or contaminants from the detecting end for accurate detection.

2. The probe holder of claim 1, said means for providing a gas being operably disposed in said means for holding the probe, and said means for providing a gas being formed with at least one orifice juxtaposed to the probe detecting end with the probe in the holder.

3. The probe holder of claim 2, wherein each orifice has a central axis and the means for holding the probe has a central axis, and wherein each orifice central axis is transversely disposed to the means for holding the probe central axis.

4. The probe holder of claim 2, said means for holding the probe comprises an abutment whereby the probe is held against the abutment in a predetermined position so that the said one orifice is operably juxtaposed to the probe detecting end.

5. The probe holder of claim 1, further comprising means for mounting the means for holding the probe to the wall of a vessel.

6. The probe holder of claim 1, said means for providing a gas further comprises a manifold for distributing said gas in several directions to the probe detecting end.

7. The probe holder of claim 2, comprising a plurality of said orifices, and said means for providing a gas comprises manifold means for distributing the gas to the orifices.

8. The probe holder of claim 2, further comprising a plurality of circumferentially disposed orifices for providing the gas to clear the probe detecting end.

9. The probe holder of claim 1, said means for holding the probe comprising a plurality of inter-engaged components in integral construction.

10. The probe holder of claim 9, said inter-engaged components forming a central orifice for slidably receiving the probe.

11. In combination:
a probe, said probe having a proximate end and a distal end, said distal end comprising means for detecting a substance, and a holder having means for holding the probe so that the probe is disposed in a predetermined position in the holder, and means for providing a gas to the distal end of the probe to clear the means for detecting for accurate detection of the substance.

12. The combination of claim 11, said means for detecting a substance comprising means for infra red detection of moisture.

13. The combination of claim 11, said holder further comprising means for seating the probe in the holder.

14. The combination of claim 11, further comprising means for mounting the combination in a process vessel wall.

15. The combination of claim 11, said combination further comprising a process vessel having a wall, and wherein said holder is mounted in said wall so that the probe distal end is operably facedly disposed with respect to the material containing the substance to be detected.

16. A system for the accurate detection of moisture content in a process material, comprising, a probe having a detecting end for detecting moisture in a process material, and means for providing a gas to the probe detecting end to clear the probe detecting end of unwanted moisture disposed on the detecting end for accurate process material moisture content determination.

17. The system of claim 16, wherein the process material is a pharmaceutical process material.

18. The system of claim 17, wherein the gas comprises one selected from air, nitrogen and an inert gas.

19. A method for making accurate detection probe readings comprising:
(a) providing a probe having a detecting end;
(b) providing a holder for holding the probe so that the probe is held in a predetermined position, said holder comprising an orifice for gas flow; and
(c) providing a gas through the orifice to the probe detecting end to clear the probe detecting end for an accurate probe reading.

20. The method of claim 19, wherein the probe detects moisture.

21. The method of claim 19, wherein step (b) further comprises providing the gas transversely to the probe detecting end.

22. The method of claim 19, wherein step (b) further comprises providing the gas intermittently between readings.

23. The method of claim 19, further comprising mounting said holder and probe in the wall of a pharmaceutical process vessel.

24. The method of claim 23, said pharmaceutical process vessel comprises a dryer, said substance comprises moisture, and said gas comprises one selected from air, nitrogen and an inert gas.

25. The method of claim 19, wherein step (c) further comprises providing the gas at a first pressure, and then immediately prior to the probe reading, providing the gas at a second pressure higher than the first pressure.

26. The method of claim 25, wherein the first pressure is no more than about 10 psi and the second pressure is at least about 10 to 45 psi.
